(19) United States
(12) Patent Application Publication
(10) Pub. No.: US 2016/0146451 A1
(43) Pub. Date: May 26, 2016

(54) KNIFE STRUCTURE

(71) Applicant: FOOYIN UNIVERSITY, KAOHSIUNG CITY (TW)

(72) Inventor: TIAN-JYE HSIEH, KAOHSIUNG CITY (TW)

(21) Appl. No.: 14/549,682

(22) Filed: Nov. 21, 2014

(51) Int. Cl. F21V 33/00; F21L 4/08; B26B 29/02

(52) U.S. Cl. CPC F21V 33/0084; B26B 29/025; F21V 33/0056; F21V 33/0076; F21L 4/08

(57) ABSTRACT

A knife structure, which comprises a knife body, a sheath for accommodating the knife body, an alert and rescue module, a plurality of LED light units disposed on the upper and lower edges of the sheath, a solar module and an energy-storing unit, wherein the alert and rescue module is disposed on the exterior of the sheath and includes an illumination module and a digital tool unit to aid in outdoor survival. Said digital tool unit is provided with a compass, a thermometer, a barometer, a music player and the like, and a solar module is disposed on the surface of the sheath for absorbing sunlight and heat to store electricity in the energy-storing unit to supply the required electricity.

### BACKGROUND OF THE INVENTION

1. Field of the Invention

The present invention relates to a knife's structure. It is equipped with some tools to perform various tasks intended for survival purposes in a wilderness environment.

2. Description of Related Art

In the aboriginal culture, adult males usually wear a saber, a status symbol entitling warriors to receive respect from the aboriginal people, to participate in tribal activities and to take responsibility for their tribes and families. A saber is also an essential tool for aboriginal life, used for felling firewood, reclaiming mountain, making hunting equipment and hunting. An aboriginal saber usually is comprised of a knife body and a scabbard for accommodating the knife body. However, the scabbard only has the function of receiving the knife body and cannot be used for multiple purposes.

Knives used by climbers are equipped with a fastener for securing a handle and a sheath, or a button between the handle and the sheath for providing a secure attachment. Accordingly, pressing the fastener or the button allows the sheath to detach from the handle, so the blade can be taken out of the sheath for use. Generally, the sheath structure on a survival knife is formed integrally, and the survival knife can be buckled to the part of the body that is more suitable for the user which is imperative. Furthermore, a device for providing enough illumination is also necessary for users to draw the blade of the knife from the sheath or to put it back into the sheath at night or under conditions of poor visibility, so as not to cut their hands. Without adequate illumination, people are vulnerable to ferocious animals in a wilderness environment and may carelessly hurt their teammates when mistaking them for attackers. Moreover, what climbers are most worried about during outdoor activities is losing their orientation, so they always carry a compass for orientating themselves in the fog or at night. However, the compasses are usually hung on climbers' belts or placed inside their pockets, where they may be forgotten or lost.

### SUMMARY OF THE INVENTION

In view of the abovementioned problems, the object of the present invention is to provide a knife structure with an alert and rescue module for outdoor survival, an illumination device and a player on the sheath, to perform various tasks.

Disclosed herein is a knife structure, comprising a knife body, a sheath for accommodating the knife body, an alert and rescue module, a plurality of LED light units disposed on the upper and lower edges of the sheath, a solar module and an energy-storing unit, wherein the alert and rescue module is disposed on the exterior of the sheath and includes an illumination module and a digital tool unit to aid in outdoor survival. The digital tool unit is provided with a compass, a thermometer, a barometer, a music player and the like, and the solar module is disposed on the lateral side of the sheath for absorbing sunlight and heat to store electricity in the energy-storing unit to supply the required electricity. Accordingly, the knife structure has functions of survival, illumination and identification when used outdoors, which assists users in dynamic observation, alertness and security.

According to an embodiment of the present invention, the digital tool unit integrates at least one of the following tools into the alert and rescue module: a compass, a thermometer, a hygrometer, a barometer, a pedometer for recording mileage, a clock for calculating time and date, a GPS for navigation, an altimeter for recording altitude, a buzzer, a reflector, a music player, an electronic insect repelling apparatus and a seismograph.

### BRIEF DESCRIPTION OF THE DRAWINGS

FIG. 1 is a perspective exploded view showing a knife structure according to the present invention

FIG. 2 is a schematic diagram showing the external appearance of a knife structure according to the present invention

FIG. 3 is a diagram showing a knife structure in an assembled state according to the present invention

FIG. 4 is a schematic diagram showing a knife structure in use according to the present invention

FIG. 5 is a schematic diagram showing a headset connected to the music player by a wire

FIG. 6 is another schematic diagram showing a headset connected to the music player in a wireless manner

### DETAILED DESCRIPTION OF THE PREFERRED EMBODIMENT

Hereinafter, an exemplary embodiment of the present invention will be described in detail with reference to the accompanying drawings.

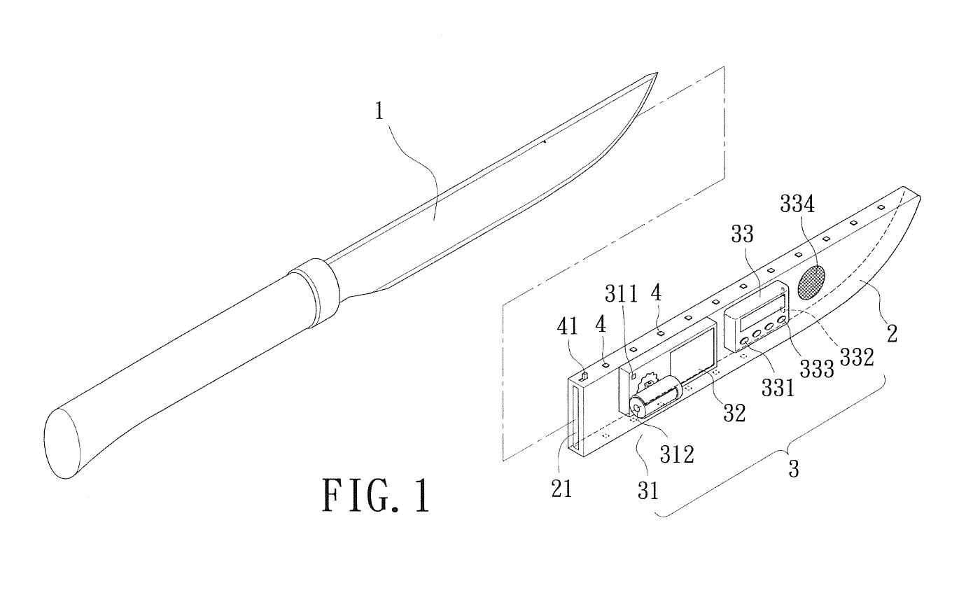

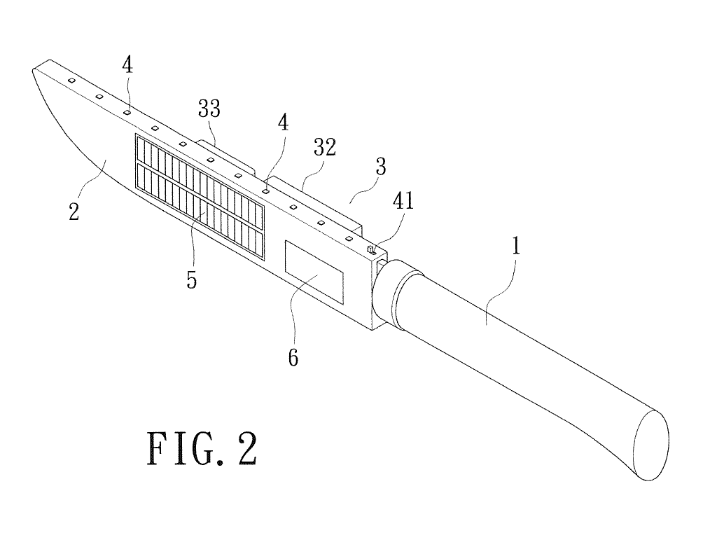

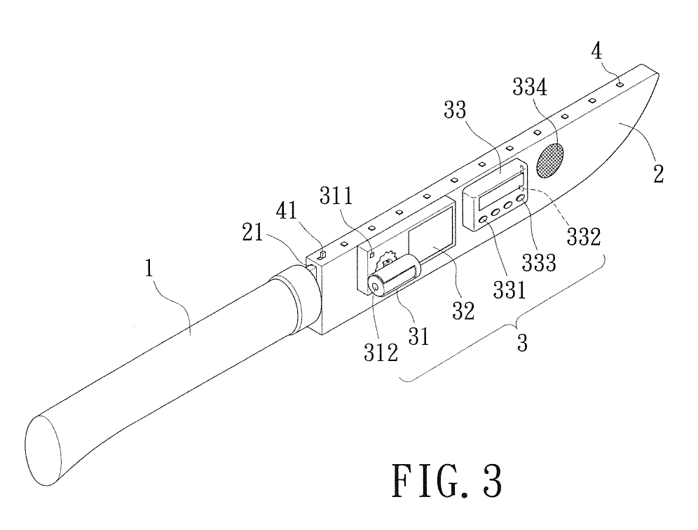

First, referring to FIGS. 1 to 3, a knife structure according to the present invention is disclosed, mainly comprising:

a knife body (1) selected from a knife, a sword, or a saw;

a sheath (2) for accommodating the knife body (1);

an alert and rescue module (3) disposed on the exterior of the sheath (2) and including an illumination module (31) and a digital tool unit (32) for aid in outdoor survival. The illumination module (31) is comprised of a switch (311) and an illumination unit (312) disposed near an opening of a blade trough (21) formed in the sheath (2). The digital tool unit (32) is provided with a compass, a thermometer, a hygrometer, a barometer, a pedometer for recording mileage, a clock for calculating the time and date, a GPS for navigation, an altimeter for recording altitude, a buzzer, a reflector, a music player (33), an electronic insect repelling apparatus, and a seismograph. The music player (33) includes a switch (331), a socket (332), a selector (333), and a loudspeaker (334);

a plurality of LED light units (4) are disposed on the upper and lower edges of the sheath (2), wherein a LED light switch (41) is disposed on the upper edge of the sheath (2) for turning the plurality of LED light units (4) on or off.

a solar module (5) is disposed on a lateral side of the sheath (2) for absorbing sunlight and heat to generate electricity; and

an energy-storing unit (6) is disposed on a lateral side of the sheath (2) to connect the solar module (5) for storing electricity and to connect the alert and rescue modules (3) and the LED light unit (4) for supplying electricity.

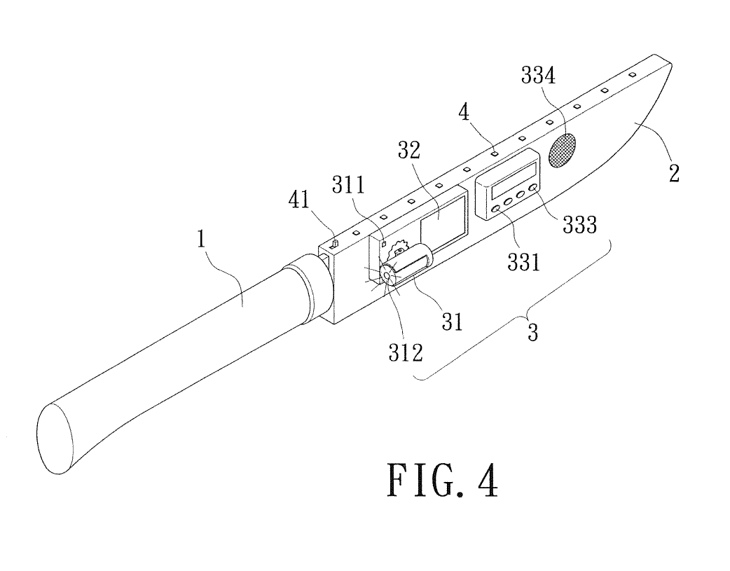

Moreover, referring to FIGS. 1-5, the knife structure has a sheath (2) for receiving the knife body (1), and the knife body (1) can be taken out of the blade trough (21) of the sheath (2) for use. The illumination unit (312) (e.g. LED light) can light the opening of the blade trough (21) when a user presses the switch (311) on the illumination module (31), allowing users to see the location of the blade trough (21) clearly and to sheathe the knife body (1) into the sheath (2) precisely (as shown in FIG. 4).

During outdoor activities such as camping, the illumination module (31) can also be used for lighting, and the digital tool unit (32) can assist users in outdoor survival. For instance, when people get lost in a wilderness environment, the compass on the digital tool unit (32) disposed on the exterior of the sheath (2) can help them is orientate themselves and users can find the temperature, humidity and barometric pressure from a thermometer, hygrometer and barometer, respectively. Moreover, the digital tool unit (32) further integrates at least one of the following tools into the alert and rescue module (3): a pedometer for recording mileage, a clock for calculating time and date, a GPS for navigation, an altimeter for recording altitude, a buzzer for sounding the alarm, a reflector, a music player (33) for playing music or a FM broadcast, an electronic insect repelling apparatus or a seismograph to warn of impending earthquakes 10-20 seconds in advance. These tools perform various tasks intended for survival purposes in a wilderness environment.

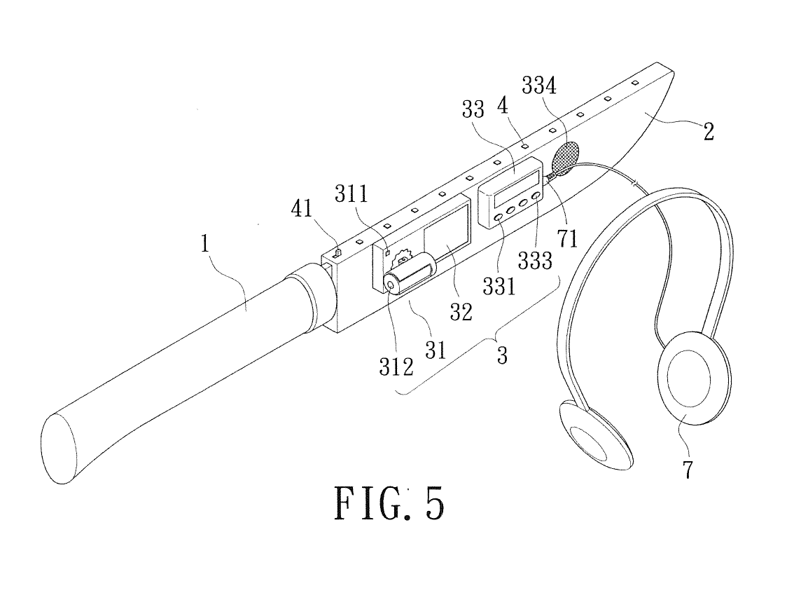

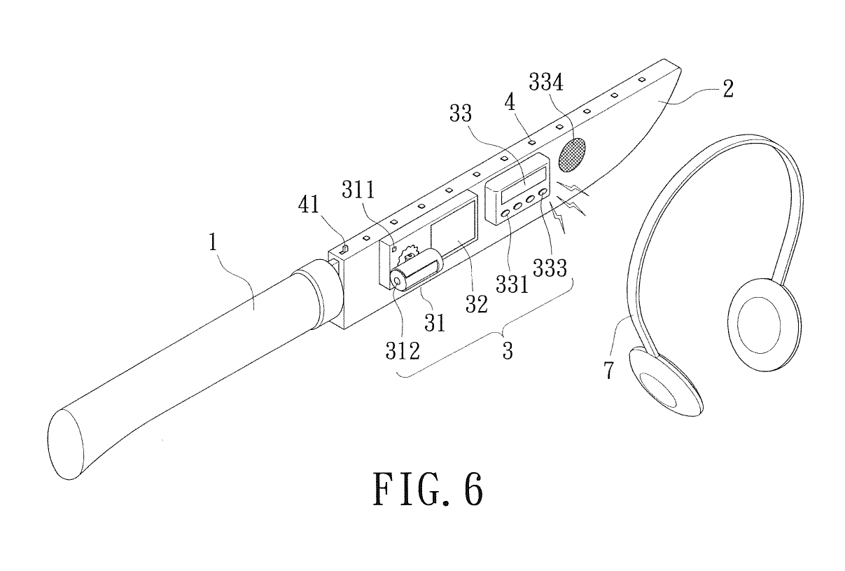

The music player (33) in the foregoing description includes a switch (331) for turning it on or off (33), a selector (333) for selecting music or a FM broadcast and a socket (332) for plugging in a connector (71) for a headset (7) (as shown in FIG. 5). When the connector (71) is not plugged into the socket (332), the music player (33) can still play music or a FM broadcast using a loudspeaker (334) or the user can connect the headset (7) to a Wireless Bluetooth Transmission, as shown in FIG. 6.

According to an embodiment of the present invention, the sheath (2) can be provided with a recess for accommodating the solar module (5) and the energy-storing unit (6) or allow the solar module (5) and the energy-storing unit (6) to be installed on a surface. The solar module (5) can absorb sunlight, as well as heat, during the day to generate and store electricity in the energy-storing unit (6). Accordingly, the energy-storing unit (6) can supply electricity to the plurality of LED light units (4) on the sheath (2) for generating light by turning on the LED light switch (41) at night or the alert and rescue module (3), e.g. the illumination module (31) and the digital tool unit (32). Adequate illumination can prevent people from hurting their teammates carelessly and protect people from animal attacks.

When the knife structure is not used, it can also act as a decoration, e.g. illumination by the LED light unit (4).

According to the above description, in comparison with the traditional technique, a knife structure according to the present invention has the following advantages:

1. Said structure is equipped with some tools to perform various tasks intended for survival purposes in a wilderness environment.

2. Said structure is provided with a plurality of LED light units on the upper and lower edges of the sheath that can be used for illumination and identification to prevent injury and protect from animal attacks or act as a decoration.

3. The solar module of the knife structure can absorb sunlight, as well as heat, to generate and store electricity in an energy-storing unit, allowing the energy-storing unit to supply electricity to a plurality of LED light units and to an alert and rescue module for energy efficiency.

What is claimed:

1. A knife structure, comprising:
a knife body;
a sheath for accommodating the knife body;
an alert and rescue module disposed on the exterior of the sheath and including an illumination module and a digital tool unit to aid in outdoor survival;
a plurality of LED light units disposed on the upper and lower edges of the sheath, wherein a LED light switch is disposed on the upper edge of the sheath for turning on or off the plurality of LED light units;
a solar module disposed on a lateral side of the sheath for absorbing sunlight and heat to generate electricity, and
an energy-storing unit disposed in the lateral side of the sheath to connect the solar module for storing electricity and to connect the alert is and rescue module and the LED light unit for supplying electricity.

2. The knife structure defined in claim 1, wherein the knife body is a knife, a sword, or a saw.

3. The knife structure defined in claim 1, wherein the alert and rescue module comprises a switch and an illumination unit disposed near an opening of a blade trough formed in the sheath.

4. The knife structure defined in claim 1, wherein the digital tool unit integrates at least one of the following tools into the alert and rescue module: a compass, a thermometer, a hygrometer, a barometer, a pedometer for recording mileage, a clock for calculating time and date, a GPS for navigation, an altimeter for recording altitude, a buzzer, a reflector, a music player, an electronic insect repelling apparatus and/or a seismograph.

5. The knife structure defined in claim 2, wherein the digital tool unit integrates at least one of the following tools into the alert and rescue module: a compass, a thermometer, a hygrometer, a barometer, a pedometer for recording mileage, a clock for calculating time and date, a GPS for navigation, an altimeter for recording altitude, a buzzer, a reflector, a music player, an electronic insect repelling apparatus, and a seismograph.

6. The knife structure defined in claim 3, wherein the digital tool unit integrates at least one of the following tools into the alert and rescue module: a compass, a thermometer, a hygrometer, a barometer, a pedometer for recording mileage, a clock for calculating time and date, a GPS for navigation, an altimeter for recording altitude, a buzzer, a reflector, a music player, an electronic insect repelling apparatus, and/or a seismograph.

7. The knife structure defined in claim 4, wherein the music player of the digital tool unit includes a switch, a socket, a selector and a loudspeaker.

8. The knife structure defined in claim 4, wherein a headset is provided and connects to the music player of the digital tool unit by a wire or in a wireless manner to transmit audio.

9. The knife structure defined in claim 5, wherein the music player of the digital tool unit includes a switch, a socket, a selector and a loudspeaker.

10. The knife structure defined in claim 5, wherein a headset is provided and connects to the music player in the digital tool unit by a wire or in a wireless manner to transmit audio.

11. The knife structure defined in claim 6, wherein the music player of the digital tool unit includes a switch, a socket, a selector and a loudspeaker.

12. The knife structure defined in claim 6, wherein a headset is provided and connects to the music player of the digital tool unit by a wire or in a wireless manner to transmit audio.
